(19) United States
(12) Patent Application Publication
(10) Pub. No.: US 2006/0288225 A1
(43) Pub. Date: Dec. 21, 2006

(54) User-centric question and answer for authentication and security

(76) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: ANDERSON & JANSSON, L.L.P., 9501 N. CAPITAL OF TX HWY. #202, AUSTIN, TX, 78759, US

(21) Appl. No.: 11/145,547

(22) Filed: Jun. 3, 2005

(51) Int. Cl. H04L 9/00

(52) U.S. Cl. 713/182

(57) ABSTRACT

A system and method for authenticating a user over a voice-based security system, includes but is not limited to posing two or more questions including at least one question independent of security significance; receiving one or more answers to the two or more questions; and if the one or more answers include at least one correct answer to one or more predetermined questions of the two or more questions, the one or more predetermined questions having security significance, allowing an authentication.

### TECHNICAL FIELD

The present application relates generally to security systems.

### SUMMARY

In one aspect, a method for authenticating a user over a voice-based system includes but is not limited to posing two or more questions including at least one question independent of security significance; receiving one or more answers to the two or more questions; and if the one or more answers include at least one correct answer to one or more predetermined questions of the two or more questions, the one or more predetermined questions having security significance, allowing an authentication. In addition to the foregoing, other method aspects are described in the claims, drawings, and text forming a part of the present application.

In another aspect, a computer program product can include a signal bearing medium bearing one or more instructions including, but not limited to one or more instructions for posing two or more questions including at least one question relatively independent of security significance, one or more instructions for receiving one or more answers to the two or more questions, and one or more instructions for allowing an authentication if the one or more answers include at least one correct answer to one or more predetermined questions of the two or more questions, the one or more predetermined questions having security significance. In addition to the foregoing, other computer program product aspects are described in the claims, drawings, and text forming a part of the present application.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer. In addition to the foregoing, other system aspects are described in the claims, drawings, and text forming a part of the present application.

In one aspect, a system includes but is not limited to a communication device including a processor; audio input and output circuitry coupled to the processor; a memory coupled to the processor; and a security module coupled to the processor, the security module configured to determine whether the processor should implement a secure protocol, the secure protocol configured to implement a user-centric authentication, the security module configured to include a question module configured to determine two or more questions including at least one question independent of security significance; and an answer module configured to allow an authentication if one or more answers received include at least one correct answer to one or more predetermined questions of the two or more questions, the one or more predetermined questions having security significance.

In addition to the foregoing, various other method, system, and/or computer program product aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the application can be obtained when the following detailed description of the disclosed embodiments is considered in conjunction with the following drawings, in which:

FIG. 1 is a block diagram of an exemplary computer architecture that supports the claimed subject matter of the present application;

FIG. 2 is a block diagram of a network environment that supports the claimed subject matter of the present application;

FIG. 3 is a block diagram of a communication device appropriate for embodiments of the subject matter of the present application; and

FIGS. 4A, 4B and 4C illustrate a flow diagram of a method in accordance with an embodiment of the subject matter of the present application.

### DETAILED DESCRIPTION OF THE DRAWINGS

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operations described hereinafter can also be implemented in hardware, software, and/or firmware and/or some combination thereof.

According to William Crossman, Founder/Director of CompSpeak 2050 Institute for the Study of Talking Computers and Oral Cultures, VIVOs, (voice-in/voice-out computers that operate using visual displays) may make written language obsolete. VIVOs potentially can perform the functions of written language without requiring people to learn to read and write and, therefore, enable illiterate people, using VIVOs, to access the stored information.

Opening the doors for potentially billions of people to electronically-stored data presents a host of issues related to security and/or authentication. More particularly, according to Crossman, billions of illiterate people will be able to access data previously available only to the computer literate. The increase in the number of people with access to the Internet will increase the need for security systems that address the enhanced security risk. Moreover, VIVO technology will increase the number of security systems reliant on voice commands and subject users to security risks present with voice related systems.

To combat the security risk inherent in a VIVO system, embodiments herein present authentication and/or security solutions practical for voice related security.

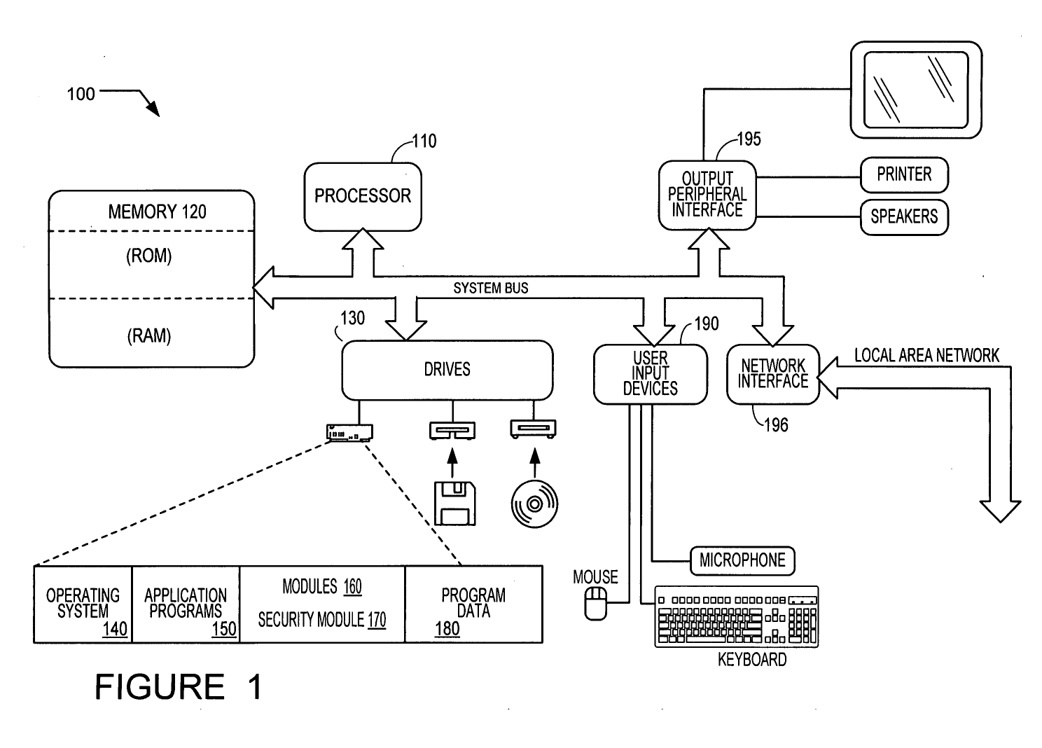

With reference to FIG. 1, depicted is an exemplary computing system for implementing embodiments. FIG. 1 includes a computer 100, which could be a VIVO-capable computer, including a processor 110, memory 120 and one or more drives 130. The drives 130 and their associated computer storage media, provide storage of computer readable instructions, data structures, program modules and other data for the computer 100. Drives 130 can include an operating system 140, application programs 150, program modules 160, such as security module 170 and program data 180. Computer 100 further includes user input devices 190 through which a user may enter commands and data. Input devices can include an electronic digitizer, a microphone, a keyboard and pointing device, commonly referred to as a mouse, trackball or touch pad. Other input devices may include a joystick, game pad, satellite dish, scanner, or the like. In one or more embodiments, user input devices 190 are VIVO enabling devices, enabling a user to provide voice activated responses and/or questions.

These and other input devices can be connected to processor 110 through a user input interface that is coupled to a system bus, but may be connected by other interface and bus structures, such as a parallel port, game port or a universal serial bus (USB). Computers such as computer 100 may also include other peripheral output devices such as speakers, which may be connected through an output peripheral interface 195 or the like. More particularly, output devices can include VIVO enabling devices capable of providing voice output in response to voice input.

Computer 100 may operate in a networked environment using logical connections to one or more remote computers, such as a remote computer. The remote computer may be a personal computer, a server, a router, a network PC, a peer device or other common network node, and can include many or all of the elements described above relative to computer 100. Networking environments are commonplace in offices, enterprise-wide computer networks, intranets and the Internet. For example, in the subject matter of the present application, computer 100 may comprise the source machine from which data is being migrated, and the remote computer may comprise the destination machine. Note however that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or adapter. When used in a WAN networking environment, computer 100 typically includes a modem or other means for establishing communications over the WAN, such as the Internet. It will be appreciated that other means of establishing a communications link between the computers may be used.

According to one embodiment, computer 100 is connected in a networking environment such that the processor 110 and/or security module 170 determine whether incoming data follows a secure protocol. The incoming data can be from a VIVO communication device or from another data source. The secure protocol can be code stored in memory 120. For example, processor 110 can determine whether an incoming call is from a VIVO, determine that a secure protocol is necessary and apply an appropriate authentication.

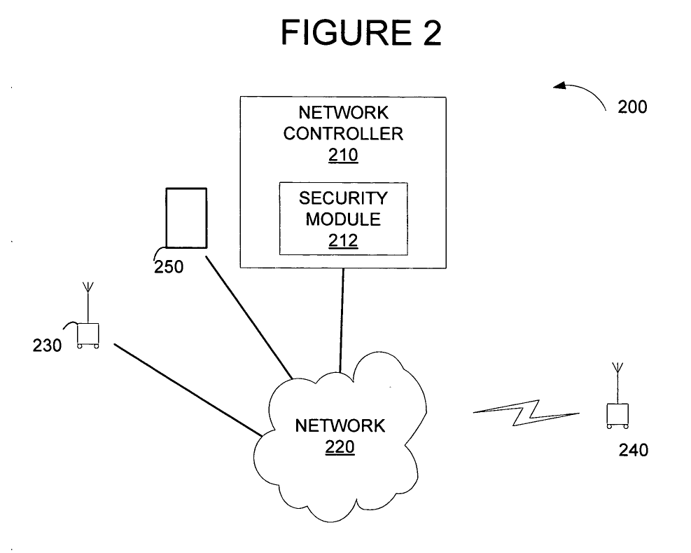

Referring now to FIG. 2, illustrated is an exemplary block diagram of a system 200 capable of being operable with VIVO computer systems and interacting with a VIVO-type computer system. System 200 is shown including network controller 210, a network 220, and one or more communication devices 230, 240, and 250. Communication devices 230, 240, and 250 may include telephones, wireless telephones, cellular telephones, personal digital assistants, computer terminals or any other devices that are capable of sending and receiving data.

Network controller 210 is connected to network 220. Network controller 210 may be located at a base station, a service center, or any other location on network 220. Network 220 may include any type of network that is capable of sending and receiving communication signals, including VIVO-type signals. For example, network 220 may include a data network, such as the Internet, an intranet, a local area network (LAN), a wide area network (WAN), a cable network, and other like communication systems. Network 220 may also include a telecommunications network, such as a local telephone network, long distance telephone network, cellular telephone network, satellite communications network, cable television network and other like communications systems that interact with computer systems. Network 220 may include more than one network and may include a plurality of different types of networks. Thus, network 220 may include a plurality of data networks, a plurality of telecommunications networks, and a combination of data and telecommunications networks and other like communication systems.

In operation, one of the communication devices 230, 240, or 250, may attempt a communication with a receiving communication device. The communication can be routed through network 220 and network controller 210 to the receiving communication device. For example, a call originator communication device 230 may attempt a call to a call recipient communication device 240. In an embodiment, controller 210 is a VIVO-enabled controller such that an audible format may be a speech format. According to an embodiment, controller 210 can include a security module 212 that can poll the caller and a call recipient 240 during call setup to pose authentication questions to secure a connection. For example, a call could be to a bank or other recipient with sensitive data requiring security.

Controller 210 can alter the format of the call by performing speech-to-text and conversion on the call when controller 210 determines the format of the call requires a format change. Controller 210 can additionally alter the format of the call by performing text-to-speech conversion on the call when controller 210 determines the format of the call requires a format change. Controller 210 can then send the call in an appropriate format to the call recipient 240. In one embodiment, controller 210 is a VIVO-enabled controller that alters speech to text or speech to computer code in accordance with the requirements of a VIVO.

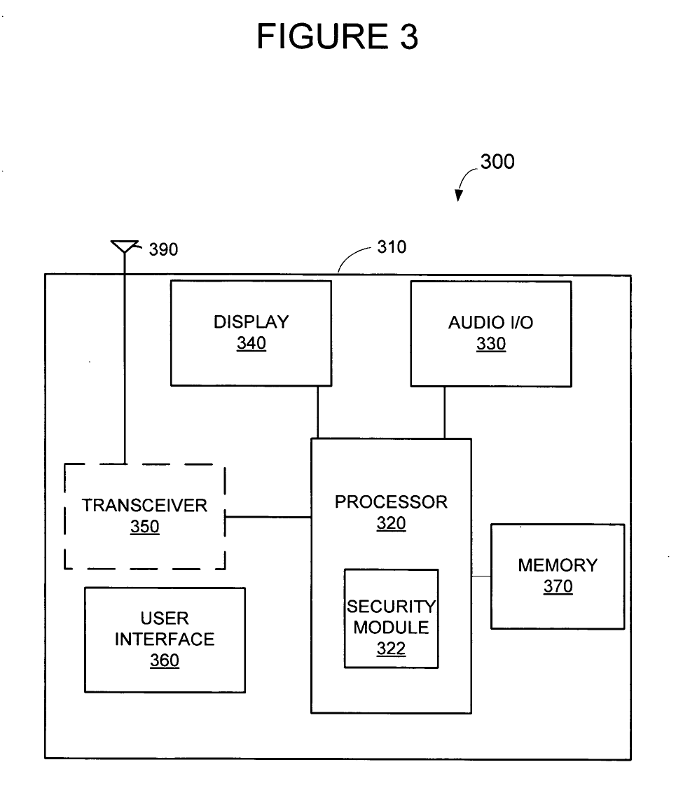

FIG. 3 is an exemplary block diagram of a communication device 300, such as communication devices 230 or 240 according to an embodiment. Communication device 300 can include a housing 310, a processor 320, audio input and output circuitry 330 coupled to processor 320, a display 340 coupled to processor 320, a user interface 360 coupled to processor 320 and a memory 370 coupled to processor 320. According to an embodiment, processor 320 includes security module 322. Security module 322 may be hardware coupled to the processor 320. Alternatively, security module 322 could be located within processor 320, or located in software located in memory 370 and executed by processor 320, or any other type of module. Memory 370 can include a random access memory, a read only memory, an optical memory, a subscriber identity module memory, or any other memory that can be coupled to a communication device. Display 340 can be a liquid crystal display (LCD), a light emitting diode (LED) display, a plasma display, or any other means for displaying information. Audio input and output circuitry 330 can include a microphone, a speaker, a transducer, or any other audio input and output circuitry. User interface 360 can include a keypad, buttons, a touch pad, a joystick, an additional display, or any other device useful for providing an interface between a user and an electronic device.

Processor 320 can be configured to control the functions of communication device 300. Communication device 300 can send and receive signals across network 220 using a transceiver 350 coupled to antenna 390. Alternatively, communication device 300 can be a device relying on twisted pair technology and not require transceiver 350.

According to an embodiment, a user can use either the user interface 360 for input and output of information to and from communication device 300 or use input and output using the audio input and output circuitry 330. Data received by communication device 300 can be displayed on display 340 and/or provided audibly through audio input and output circuitry 330. Communication device 300 can operate as a VIVO when operated in a fully audible format. For example, VIVO applications can be stored on memory 370 and processed by processor 320.

According to one embodiment, the processor 320 and/or security module 322 can determine whether an incoming call follows a secure protocol. The secure protocol can be code stored in memory 370. For example, processor 320 can determine an incoming call is from a VIVO, determine that a secure protocol is necessary and apply an appropriate authentication. Conversely, processor 320 and/or security module 322 can determine that an outgoing call should follow a secure protocol and implement the secure protocol.

In one embodiment, either or both computer 100 and communication device 300 operate as VIVOs that are capable of implementing a secure protocol for incoming and/or outgoing audible data and/or speech. The secure protocol, in one embodiment, implements a user-centric question and answer to authenticate one or both of incoming and outgoing data when an auditory format is detected. For example, if computer 100 or communication device 300 is used to communicate with a bank, the bank could implement a secure protocol by operating a computer 100 with a security module or a communication device 300 with a security module. Likewise, the bank could operate via a secure network such as a network described in FIG. 2, and implement a secure protocol via network controller 210 implementing a security protocol via a security module.

In one embodiment, the security module is configured to determine whether a processor (in either computer 100, communication device 300, or in a network controller) should implement a secure protocol, the secure protocol configured to implement a user-centric authentication. More particularly, the security module could include a question module configured to determine two or more questions, the two or more questions could be in response to an authentication request, including at least one question independent of security significance, and an answer module configured to allow an authentication if one or more answers received include at least one correct answer to one or more predetermined questions of the two or more questions, the one or more predetermined questions having security significance.

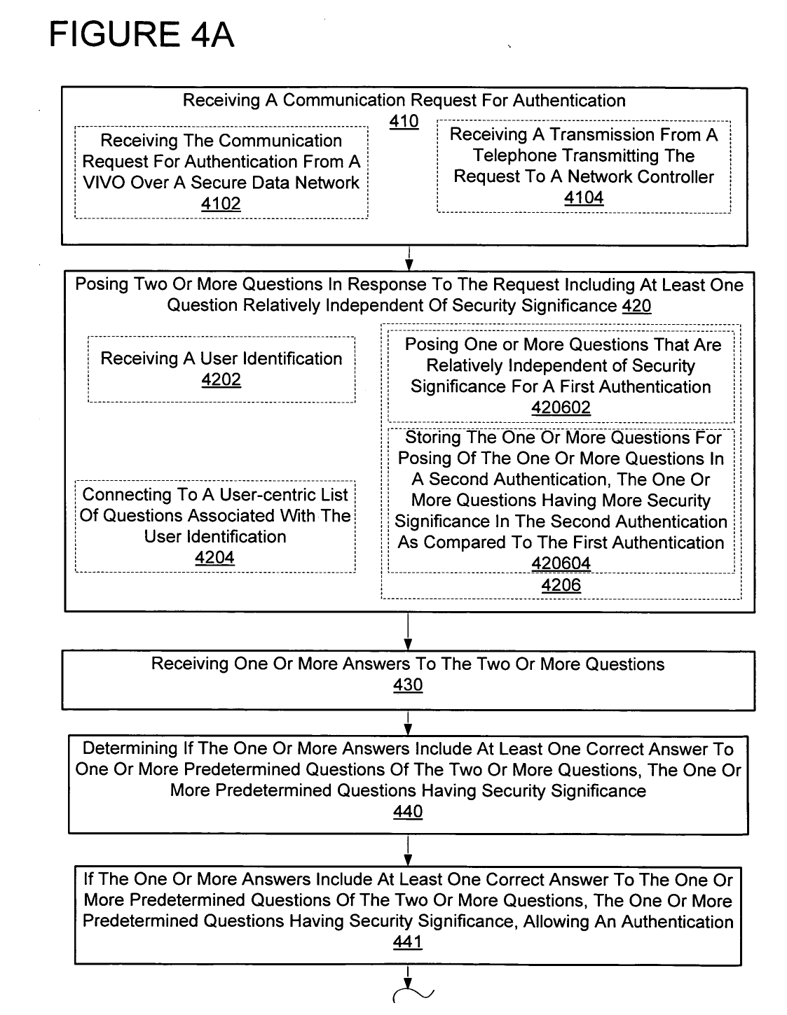

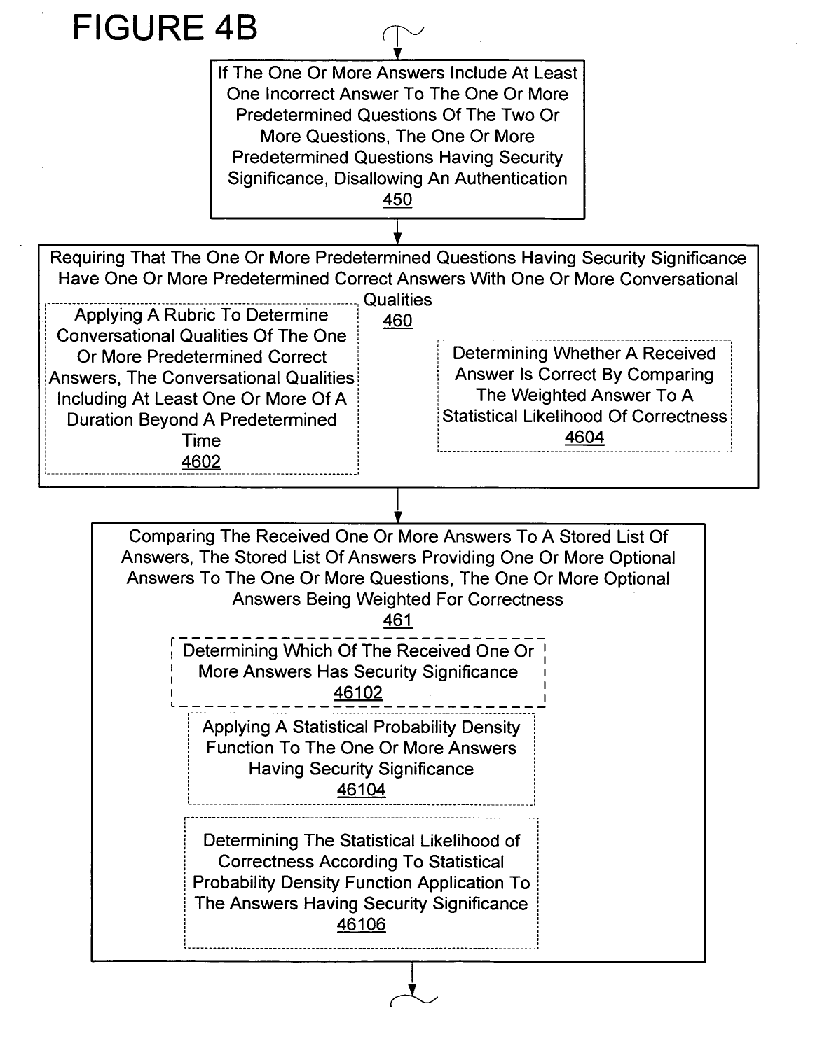

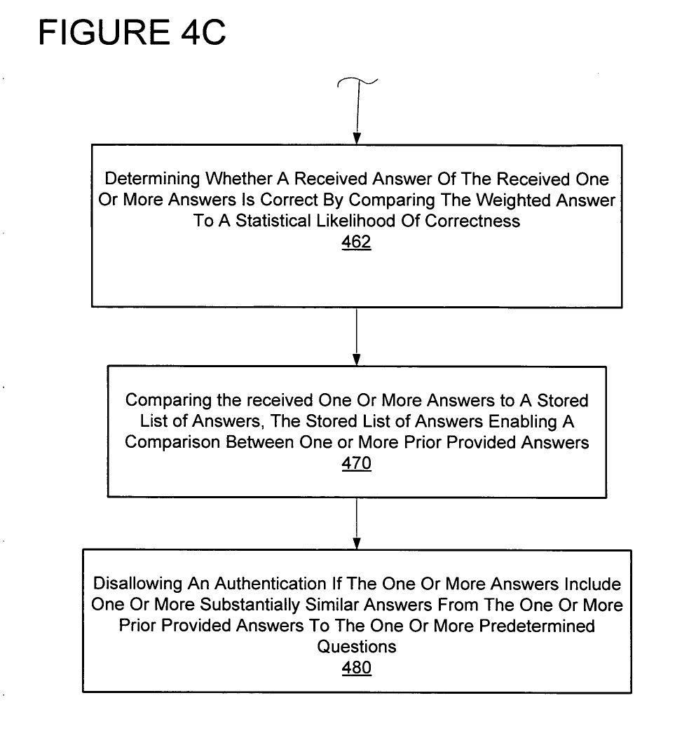

Referring now to FIGS. 4A, 4B and 4C, an exemplary flow diagram illustrates the operation of the processor 320 and/or security module 322 and/or network controller 210 according to an embodiment. One of skill in the art with the benefit of the present disclosure will appreciate that act(s) can be taken by security module 322, network controller 210, processor 110, and/or security module 170. The acts are generally referred to as being taken by a security processor.

Block 410 provides for an operation of receiving a communication request for authentication. The request could be an oral request over a telephone to a security processor from a VIVO or the like. For example, a bank can receive a request to authenticate a customer, or the like. A security processor can determine that an authentication session is required. For example, the determination can be a determination by a bank that a user wishes to log into the bank. The determination can include a determination that a user is using a telephone to log into the bank via audible-only methods of communication. For example, a bank can operate via a network capable of accepting auditory communications from a user and have a computer, such as computer 100, or network controller 210, respond with auditory communications back to the user. Depicted in block 410 is optional block 4102, which provides that the receiving the communication request for authentication can be receiving a request for authentication from a voice-in/voice-out (VIVO) computer over a secure data network. For example, the request for authentication can be an oral request from a person using computer 100 or communication device 300. Also depicted in block 410 is optional block 4104, which provides for receiving a transmission from a telephone transmitting the request to a network controller.

Block 420 provides for posing two or more questions in response to the request including at least one question relatively independent of security significance. For example, the security processor could prompt a user calling into a bank with a plurality of questions for authentication and/or security purposes; a series of questions can be posed to a user to verify that the user is who he claims to be. At least one question can be independent of security significance such that the security processor poses two or more questions that are intended for eavesdroppers, the one or more questions interspersed with questions that are security related. Block 420 includes optional block 4202, which depicts that the security processor can receive a user identification. For example, the user can identify himself by first stating a name, a code, a numerical sequence, a social security number, or the like that initiates the posing of the two or more questions. Block 420 further depicts optional block 4204, which provides for connecting to a user-centric list of questions associated with the user identification. For example, once the security processor determines that a user identifies himself with a code or the like, the security processor connects that user identification with a user-centric list of questions that can be used to verify the identification provided.

In block 420, optional block 4206 is also depicted illustrating that optionally part of the security processor posing two or more questions including at least one question relatively independent of security significance can include, as shown in block 420602 posing one or more questions that are relatively independent of security significance for a first authentication; and, as shown in block 420604, storing the one or more questions for posing of the one or more questions in a second authentication, the one or more questions having more security significance in the second authentication as compared to the first authentication.

Block 430 provides for receiving, such as by the security processor, one or more answers to the two or more questions. For example, a user can respond to the questions posed by the security processor by answering some or all of the questions posed.

In block 440, the security processor, for example, determines if the one or more answers include at least one correct answer to one or more predetermined questions of the two or more questions, the one or more predetermined questions having security significance. In block 441, if the answers include at least one correct answer to the one or more predetermined questions, the security processor allows an authentication. For example, a bank security processor can allow a user to authenticate with the bank over a telephone if the user answers correctly to predetermined questions interspersed among other questions posed to the user.

In block 450, if the one or more answers include at least one incorrect answer to the one or more predetermined questions of the two or more questions, the one or more predetermined questions having security significance, the security processor disallows an authentication. More particularly, a security processor can determine that all or a subset of the predetermined questions having security significance, and if all or a subset of the predetermined questions having security significance are answered incorrectly, the security processor can disallow an authentication. The determination of which of the predetermined questions have security significance and how many questions should be answered incorrectly can be according to system requirements, which can include a level of security required by a system.

In block 460, in an embodiment, the security processor requires that the one or more predetermined questions having security significance have one or more predetermined correct answers with one or more conversational qualities.

Depicted within block 460 is optional block 4602, illustrating that the requiring that the one or more predetermined questions having security significance have one or more predetermined correct answers having one or more conversational qualities can include applying a rubric to determine conversational qualities of the one or more predetermined correct answers, the conversational qualities including at least one or more of a duration beyond a predetermined time. The rubric can include guidelines under which a question and answer session is classed as conversational or not conversational. The conversational qualities can include qualities such as the duration of the answer beyond a predetermined length of time. The rubric can further include guidelines beyond qualities concerning the duration of an answer to determine whether or not an answer is conversational, including, but not limited to comparing an answer to a prior provided answer and determining whether an answer is machine created. For example, if an answer provided has qualities that indicate an exact reproduction of a portion of an answer, there is a likelihood that the answer was not provided by a human user.

Also depicted is optional block 4604, which includes determining whether a received answer is correct by comparing the weighted answer to a statistical likelihood of correctness. Block 4604 addresses conversational type answers in that most conversational answers are not as straightforward as other types of answers. The statistical likelihood of correctness can relate to the closeness of a given answer to several model answers to a question. For example, if a user is asked what type of weather he/she prefers, model answers could be specific such as 65 degrees and partly cloudy. In reality, a user might respond with an answer that includes the words “over cast”, “fall-type weather”, “Indian summer”, “typical upper Northwest type weather”, or the like. Such related weather indications could be statistically more likely to be correct as compared to answers indicative of mid-summer type weather. An answer that was “summer weather” for example, would receive less weight than an answer that was “fall weather.”

Block 461 provides for comparing the received one or more answers to a stored list of answers, the stored list of answers providing one or more optional answers to the one or more questions, the one or more optional answers being weighted for correctness. For example, the answers provided in a conversational style by a user can include answers stored in a data store of answers. Depending on the security system requirements, the data store can be inclusive of all or some answers considered “correct” and all or some answers considered “incorrect”; or optionally include only key words that are detected in conversation that weight the correctness of an answer. For example, the data store can include key words that are detected during a conversation, and if the key words are detected, the correctness of an answer can be weighted accordingly. The data store can further include answers considered “correct” that can operate to weight the correctness of an answer.

Depicted in block 461 is optional block 46102, which provides that the security processor can determine which of the received one or more answers have security significance. Further depicted is optional block 46104, which provides for applying a statistical probability density function to the one or more answers having security significance. The statistical probability density function can be a function most closely adapted to analyzing conversational speech for detecting key words or the like.

Block 461 further depicts optional block 46106, which provides for determining the statistical likelihood of correctness according to statistical probability density function application to the answers having security significance. For example, the function can be applied to only those answers having security significance. The answers that do not have security significance can be ignored. Of those answers having security significance, a probability density function, such as a function appropriate for interpreting speech and speech related statistical qualities can be applied to the answers to determine whether or not an answer is correct. For example, the function appropriate for interpreting speech can be applied to determine relative correctness of an answer by applying a veracity likelihood statistical model. In such a model, a data store holding correct answers may or may not be required depending on the security requirements of a system.

Block 462 provides for determining whether a received answer of the received one or more answers is correct by comparing the weighted answer to a statistical likelihood of correctness. For example, the weighted answer could be weighted according to known qualities of a user, such as presence of key words that are detected in conversation that weight the correctness of an answer as described above.

Block 470 provides for comparing the received one or more answers to a stored list of answers, the stored list of answers enabling a comparison between one or more prior provided answers. Block 480 provides for disallowing an authentication if the one or more received answers include one or more substantially similar answers from the one or more prior provided answers to the one or more predetermined questions. More particularly, as one of skill in the art with the benefit of the present disclosure will appreciate, there is a certain degree of similarity which the system could allow for the answers. However, if the received answers are statistically similar to the one or more prior provided answers to the one or more predetermined questions, the system can determine that a machine reproduction o might have occurred and, therefore, disallow an authentication.

Those with skill in the computing arts will recognize that the disclosed embodiments have relevance to a wide variety of applications and architectures in addition to those described above. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified blocks performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (d) a communications system (e.g., a networked system, a telephone system, a Voice over IP system, etc.), (e) a business entity (e.g., an Internet Service Provider (ISP) entity such as Comcast Cable, Quest, Southwestern Bell, etc.); a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

We claim:

1. A method for authenticating a user over a voice-based system, the method comprising:
posing two or more questions including at least one question relatively independent of security significance;
receiving one or more answers to the two or more questions; and
if the one or more answers include at least one correct answer to one or more predetermined questions of the two or more questions, the one or more predetermined questions having security significance, allowing an authentication.

2. The method of claim 1 further comprising:
receiving a communication request for authentication.

3. The method of claim 1 further comprising:
if the one or more answers include at least one incorrect answer to the one or more predetermined questions of the two or more questions, the one or more predetermined questions having security significance, disallowing an authentication.

4. The method of claim 1 further comprising:
comparing the received one or more answers to a stored list of answers, the stored list of answers enabling a comparison between one or more prior provided answers; and
disallowing an authentication if the one or more answers include one or more substantially similar answers from the one or more prior provided answers to the one or more predetermined questions.

5. The method of claim 1 further comprising:
requiring that the one or more predetermined questions having security significance have one or more predetermined correct answers with one or more conversational qualities.

6. The method of claim 5 wherein the requiring that the one or more predetermined questions having security significance have one or more predetermined correct answers with one or more conversational qualities includes:
applying a rubric to determine conversational qualities of the one or more predetermined correct answers, the conversational qualities including at least one or more of a duration beyond a predetermined time.

7. The method of claim 1 further comprising:
comparing the received one or more answers to a stored list of answers, the stored list of answers providing one or more optional answers to the one or more questions, the one or more optional answers being weighted for correctness; and
determining whether a received answer of the received one or more answers is correct by comparing the one or more optional answers being weighted for correctness to a statistical likelihood of correctness.

8. The method of claim 7 wherein the comparing the received one or more answers to a stored list of answers, the stored list of answers providing one or more optional answers to the one or more questions, the one or more optional answers being weighted for correctness includes:
determining which of the received one or more answers have security significance;
applying a statistical probability density function to the answers having security significance; and
determining the statistical likelihood of correctness according to a statistical probability density function applied to the answers having security significance.

9. The method of claim 2 wherein the receiving a communication request for authentication includes:
receiving the communication request for authentication from a voice-in/voice-out (VIVO) computer over a secure data network.

10. The method of claim 2 wherein the receiving a communication request for authentication includes:
receiving a transmission from a telephone transmitting the request to a network controller.

11. The method of claim 1 wherein the posing two or more questions including at least one question relatively independent of security significance includes:
receiving a user identification; and
connecting to a user-centric list of questions associated with the user identification.

12. The method of claim 1 wherein the posing two or more questions including at least one question relatively independent of security significance includes:
posing one or more questions that are relatively independent of security significance for a first authentication; and
storing the one or more questions for posing of the one or more questions in a second authentication, the one or more questions having more security significance in the second authentication as compared to the first authentication.

13. A computer program product comprising:
a signal bearing medium bearing
one or more instructions for posing two or more questions including at least one question relatively independent of security significance;
one or more instructions for receiving one or more answers to the two or more questions; and
one or more instructions for allowing an authentication if the one or more answers include at least one correct answer to one or more predetermined questions of the two or more questions, the one or more predetermined questions having security significance.

14. The computer program product of claim 13 wherein the signal bearing medium comprises:
a recordable medium.

15. The computer program product of claim 13 wherein the signal bearing medium comprises:
a transmission medium.

16. The computer program product of claim 13 further comprising:
one or more instructions for receiving a communication request for authentication.

17. The computer program product of claim 13 further comprising:
one or more instructions for disallowing an authentication if the one or more answers include at least one incorrect answer to one or more predetermined questions of the two or more questions, the one or more predetermined questions having security significance.

18. The computer program product of claim 13 further comprising:
one or more instructions comparing the received one or more answers to a stored list of answers, the stored list of answers enabling a comparison between one or more prior provided answers; and
one or more instructions disallowing an authentication if the one or more answers include one or more substantially similar answers from the one or more prior provided answers to the one or more predetermined questions.

19. The computer program product of claim 13 further comprising:
one or more instructions for requiring that the one or more predetermined questions having security significance have one or more predetermined correct answers with one or more conversational qualities.

20. The computer program product of claim 19 wherein the one or more instructions for requiring that the one or more predetermined questions having security significance have one or more predetermined correct answers with one or more conversational qualities include:
one or more instructions for applying a rubric to determine conversational qualities of the one or more predetermined correct answers, the conversational qualities including at least one or more of a duration beyond a predetermined time.

21. The computer program product of claim 13 further comprising:
one or more instructions for comparing the received one or more answers to a stored list of answers, the stored list of answers providing one or more optional answers to the one or more questions, the one or more optional answers being weighted for correctness; and
one or more instructions determining whether a received answer of the received one or more answers is correct by comparing the one or more optional answers being weighted for correctness to a statistical likelihood of correctness.

22. The computer program product of claim 21 wherein the
one or more instructions for comparing the received one or more answers to a stored list of answers, the stored list of answers providing one or more optional answers to the one or more questions, the one or more optional answers being weighted for correctness include:
one or more instructions for determining which of the received one or more answers have security significance;
one or more instructions for applying a statistical probability density function to the answers having security significance; and
one or more instructions for determining the statistical likelihood of correctness according to a statistical probability density function applied to the answers having security significance.

23. The computer program product of claim 16 wherein the one or more instructions for receiving a communication request for authentication include one or more instructions for receiving the communication request for authentication from a voice-in/voice-out (VIVO) computer over a secure data network.

24. The computer program product of claim 16 wherein the one or more instructions for receiving a communication request for authentication include:
one or more instructions for receiving a transmission from a telephone transmitting the request to a network controller.

25. The computer program product of claim 13 wherein the one or more instructions for posing two or more questions including at least one question relatively independent of security significance include:
one or more instructions for receiving a user identification; and
one or more instructions for connecting to a user-centric list of questions associated with the user identification.

26. The computer program product of claim 13 wherein the one or more instructions for posing two or more questions including at least one question relatively independent of security significance include:
one or more instructions for posing one or more questions that are relatively independent of security significance for a first authentication; and
one or more instructions for storing the one or more questions for posing of the one or more questions in a second authentication, the one or more questions having more security significance in the second authentication as compared to the first authentication.

27. A communication device comprising:
a processor;
audio input and output circuitry coupled to the processor;
a memory coupled to the processor; and
a security module coupled to the processor, the security module configured to determine whether the processor should implement a secure protocol, the secure protocol configured to implement a user-centric authentication, the security module configured to include
a question module configured to determine two or more questions including at least one question independent of security significance, and
an answer module configured to allow an authentication if one or more answers received include at least one correct answer to one or more predetermined questions of the two or more questions, the one or more predetermined questions having security significance.

28. The communication device of claim 27 wherein the security module is coupled to the processor, located within the processor, and/or located in the memory.

29. The communication device of claim 27 wherein the memory is one or more of random access memory, read only memory, an optical memory, and/or a subscriber identity module memory.

30. The communication device of claim 27 wherein the audio input and output circuitry includes one or more of a microphone, a speaker, a transducer, and/or audio input and output circuitry.

31. The communication device of claim 27 further comprising:
a display coupled to the processor, the display being one or more of a liquid crystal display (LCD), a light emitting diode (LED) display, and/or a plasma display; and
a user interface coupled to the processor, the user interface including one or more of a keypad, one or more buttons, a touch pad, a joystick, and/or a device for providing an interface between a user and an electronic device.

32. The communication device of claim 27 further comprising a housing coupled to the processor, the housing encasing the memory, the processor, and the audio input and output circuitry.

33. A network security system comprising:
a network controller;
a processor coupled to the network controller;
a memory coupled to the processor;
a receiver coupled to the processor; and
a security module coupled to the memory, the security module configured to determine whether the processor should implement a secure protocol, the secure protocol configured to implement a user-centric authentication, the security module configured to include
a question module configured to determine two or more questions including at least one question independent of security significance, and
an answer module configured to allow an authentication if one or more answers received include at least one correct answer to one or more predetermined questions of the two or more questions, the one or more predetermined questions having security significance.

34. The network security system of claim 33 wherein the network controller is a controller for a data network, the data network being one or more of the Internet, an intranet, a local area network (LAN), a wide area network (WAN), a cable network, a telecommunications network, a local telephone network, a long distance telephone network, a cellular telephone network, a satellite communications network, and/or a cable television network.
